(19) United States
(12) Patent Application Publication
(10) Pub. No.: US 2013/0083167 A1
(43) Pub. Date: Apr. 4, 2013

(54) PROJECTOR APPARATUS AND VIDEO DISPLAY METHOD

(71) Applicant: Jun MIYAUCHI, Kanagawa (JP)

(72) Inventor: Jun MIYAUCHI, Kanagawa (JP)

(73) Assignee: Sony Corporation, Tokyo (JP)

(21) Appl. No.: 13/616,646

(22) Filed: Sep. 14, 2012

(30) Foreign Application Priority Data
Sep. 30, 2011 (JP) 2011-216698

(51) Int. Cl. H04N 5/64; H04N 13/02; H04N 5/14

(52) U.S. Cl. 348/46; 348/571; 348/744; 348/E05.128; 348/E13.074; 348/E05.062

(57) ABSTRACT

There is provided a projector apparatus including a terminal unit supplied with video data output by a source apparatus; a video projection processing unit that generates a projection video based on the video data and projects the generated projection video through a projection lens, a distance detection unit that detects a distance to a display surface on which the projection video projected through the projection lens is displayed, a projection angle detection unit that detects a projection angle of the projection video projected through the projection lens, and a control unit that calculates a display size of the projection video on the display surface based on the distance detected by the distance detection unit and the projection angle detected by the projection angle detection unit and transmits the calculated display size as the data regarding the display capability of the projector apparatus from the terminal unit to the source apparatus.

### BACKGROUND

The present disclosure relates to a projector apparatus projecting a video on a screen or the like and a video display method applied to the projector apparatus, and more particularly, to a projector apparatus and a video display method applied to display a stereoscopic video.

There are projector apparatuses that transmit (project) a video on a screen so that users viewing the screen can perceive a three-dimensional video (stereoscopic video). The projector apparatuses alternately display right-eye and left-eye videos on a screen at a predetermined period (for example, a field period). Then, users can view the displayed videos using stereoscopic video viewing glasses such as liquid crystal shutter glasses of which open and closed states are controlled in synchronization with a video display period.

However, a method of three-dimensionally displaying a stereoscopic video on a screen is changed depending on the size of a video displayed on the screen. FIGS. 13A to 13C illustrate different stereoscopic effects depending on the size of a video displayed on a screen.

For examples, when W1 is assumed to be a parallax difference between a right-eye display object XR and a left-eye display object XL in a video projected on a screen 1a with a relatively small size, as shown in FIG. 13A, the display objects XR and XL are seen to protrude only by a distance Y1 toward the front from the screen la to viewers.

On the other hand, when the video having the same contents is enlarged and displayed on a screen 1b larger than the screen 1a without change, as shown in FIG. 13B, the parallax difference between the right-eye display object XR and the left-eye display object XL is W2, larger than W1. Therefore, a distance Y2 by which the display objects XR and XL are seen to protrude from the screen 1b is longer than the distance Y1 of the smaller screen.

To correct a difference AY between the distances Y1 and Y2, the parallax difference between the right-eye display object XR and the left-eye display object XL on the screen 1b should be corrected to the smaller parallax difference W1, as shown in FIG. 13C. By correcting the parallax difference on the screen 1b from W2 to W1, the distances by which the display objects XR and XL are seen to protrude can be set to the same distance Y1 as in FIG. 13A.

Japanese Unexamined Patent Application Publication No. H09-9299 discloses a system in which a video projected by a projector apparatus is stereoscopically displayed using liquid crystal shutter glasses worn by a viewer.

Further, Japanese Unexamined Patent Application Publication No. 2010-258609 discloses a technology in which, when video data to be stereoscopically viewed in a game console or the like is generated, data regarding a display capability is acquired from a display apparatus connected to the game console and stereoscopic video data suitable for the display capability is generated. In Japanese Unexamined Patent Application Publication No. 2010-258609, for example, data called extended display identification data (EDID) is used as the data of the display capability.

### SUMMARY

As described above, to display the stereoscopic video using the projector apparatus, the parallax difference is preferably set in accordance with the distance between the screen and the projector apparatus.

That is, in the case of a video display apparatus displaying a video for which the size of a liquid crystal display panel or the like is constant, a parallax difference suitable for the size of the display panel of the video display apparatus is set, and therefore an appropriate stereoscopic sense is obtained. On the other hand, in the case of a projector apparatus projecting a video, a fixed parallax difference is not preferably set since a screen size is different depending on a use environment. In particular, in a projector apparatus including a zoom lens as a projection lens, the size of a video to be displayed can be adjusted by adjusting the zoom lens even when a projection distance between the projector apparatus to a screen is the same. The parallax difference is not preferably determined under a fixed condition.

It is desirable to provide a projector apparatus and a video display method capable of setting an appropriate parallax when the projector apparatus projects a stereoscopic video.

According to an embodiment of the present disclosure, there is provided a projector apparatus including a terminal unit that is supplied with video data output by a source apparatus and transmits data regarding a display capability of the projector apparatus to the source apparatus, and a video projection processing unit that projects the projection video generated based on the video data input to the terminal unit through a projection lens.

The projector apparatus further includes a distance detection unit that detects a distance to a display surface on which the projection video projected through the projection lens is displayed, and a projection angle detection unit that detects a projection angle of the projection video projected through the projection lens. The projector apparatus further includes a control unit that calculates a display size of the video on the display surface based on the detected distance to the display surface and the detected projection angle and transmits the calculated display size as data regarding a display capability of the projector apparatus from the terminal unit to the source apparatus.

According to another embodiment of the present disclosure, there is provided a video display method including generating a projection video based on video data input from a source apparatus to a terminal unit and displaying the projection video by projecting the generated projection video through a projection lens. The video display method further includes detecting a distance to a display surface on which the projection video projected through the projection lens is displayed, and detecting a projection angle of the projection video projected through the projection lens. The video display method further includes calculating a display size of the projection video on the display surface based on the distance detected in detecting the distance and the projection angle detected in detecting the projection angle, and transmitting the display size calculated in calculating the display size to the source apparatus.

According to the embodiments of the present disclosure described above, the display size of the video projected through the projection lens can be calculated and the calculated display size can be transmitted to the source apparatus. Accordingly, the source apparatus can perform a process corresponding to the display size in generating video data and display the satisfactory video corresponding to the display size.

According to the embodiments of the present disclosure, the display size of the projection video can be obtained. Thus, the acquired display size can be transmitted to the source apparatus of the video, and a terminal unit of the source apparatus can receive the video data subjected to the video processing corresponding to the display size and project the video data. For example, when a stereoscopic video is displayed, it is possible to display a video obtained by adjusting a parallax between right-eye and left-eye videos to a parallax suitable for the actual display size.

### BRIEF DESCRIPTION OF THE DRAWINGS

FIG. 1 is a diagram illustrating an example of a video projection system according to an embodiment of the present disclosure;

FIG. 2 is a block diagram illustrating examples of the configurations of a projector apparatus and a reproduction apparatus according to the embodiment of the present disclosure;

FIG. 3 is a block diagram illustrating an example of the configuration of transmission and reception sides through an HDMI cable according to the embodiment of the present disclosure;

FIGS. 4A and 4B illustrate waveforms of projection distance measurement examples according to the embodiment of the present disclosure;

FIG. 5 is a diagram illustrating a projection angle measurement example according to the embodiment of the present disclosure;

FIG. 6 is a flowchart illustrating an example of a power-on process according to the embodiment of the present disclosure;

FIG. 7 is a flowchart illustrating an example of a process of setting a display size through a menu operation according to the embodiment of the present disclosure;

FIG. 8 is a diagram illustrating an example of a configuration in which an EDID storage unit of the projector apparatus is updated according to the embodiment of the present disclosure;

FIG. 9 is a flowchart illustrating an example of a process of updating the display size according to the embodiment of the present disclosure;

FIG. 10 is a flowchart illustrating an example of a process in the reproduction apparatus according to the embodiment of the present disclosure;

FIG. 11 is a block diagram illustrating examples of the configurations of a projector apparatus and a reproduction apparatus according to another embodiment of the present disclosure;

FIG. 12 is a flowchart illustrating a parallax adjustment example in the projector apparatus according to another embodiment of the present disclosure; and

FIGS. 13A to 13C illustrate a relation between a display size and a parallax when a stereoscopic video is displayed.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

An embodiment of the present disclosure will be described in the following order.

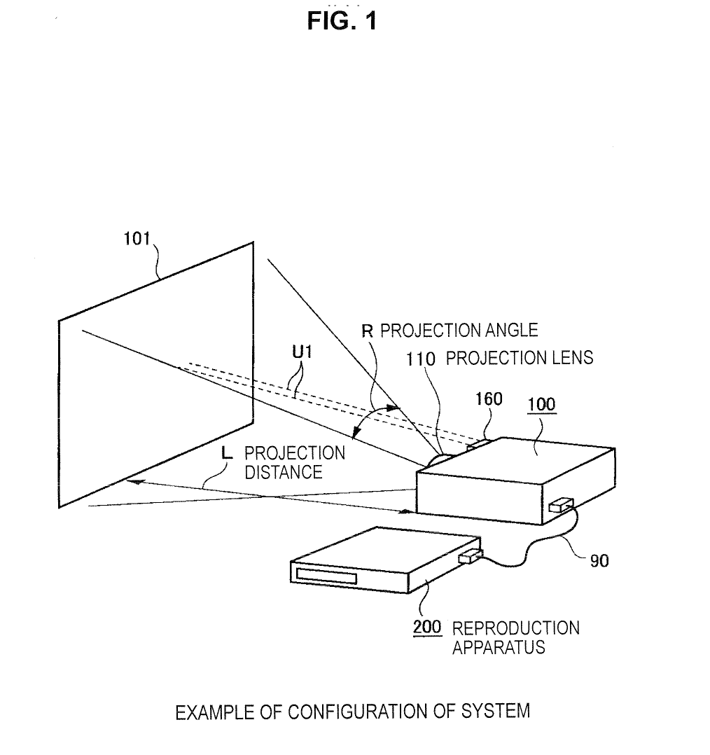

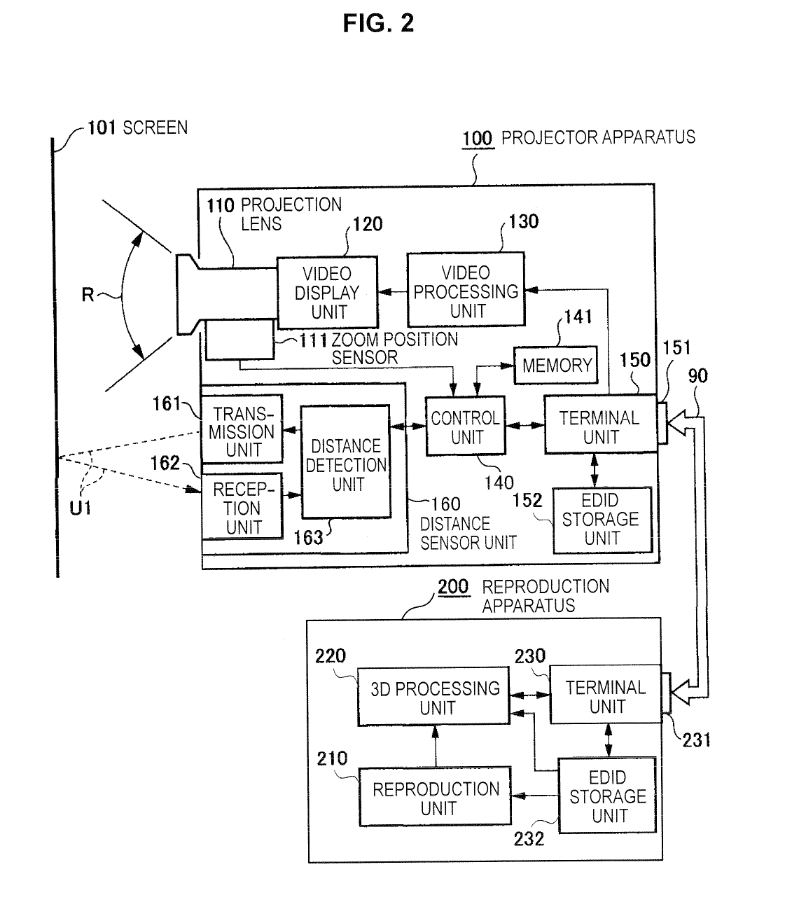

1. Configurations of Projector Apparatus and Reproduction Apparatus (FIGS. 1 and 2)

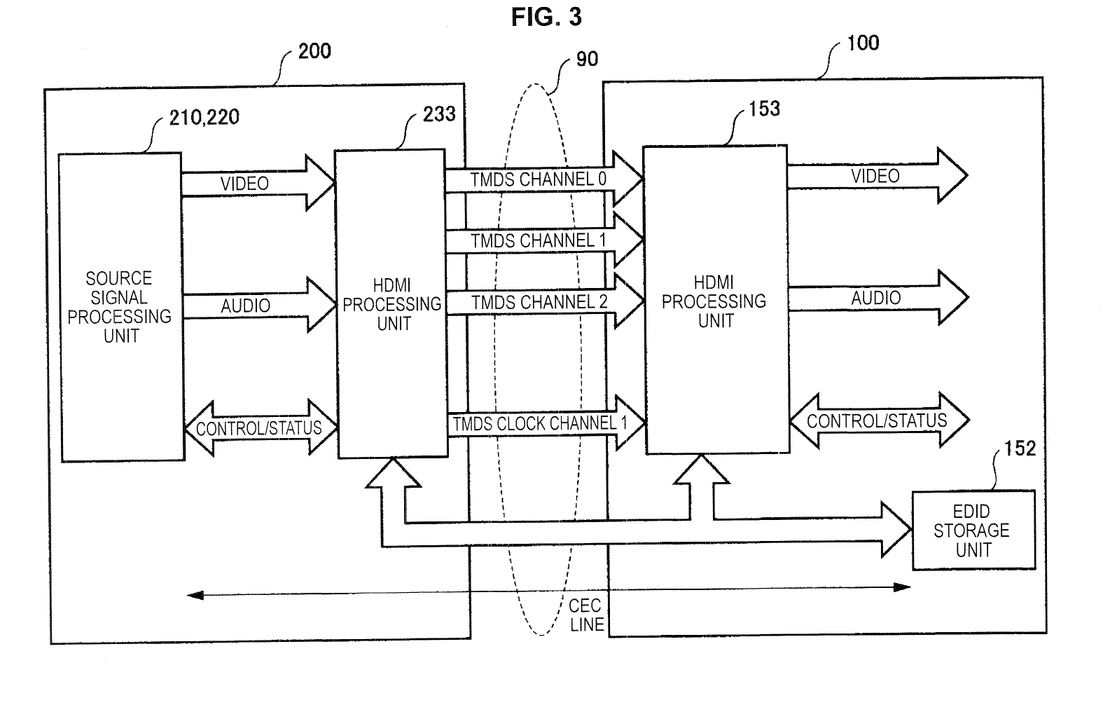

2. Configuration of Transmission and Reception with HDMI Cable (FIG. 3)

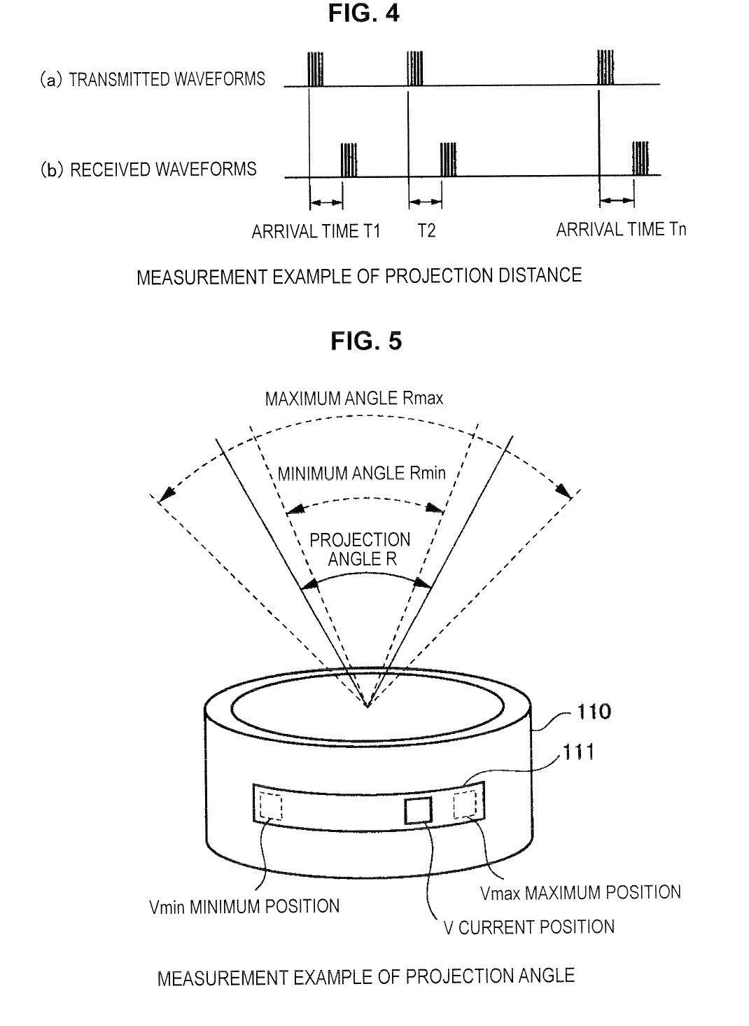

3. Process of Detecting Display Size (FIGS. 4 and 5)

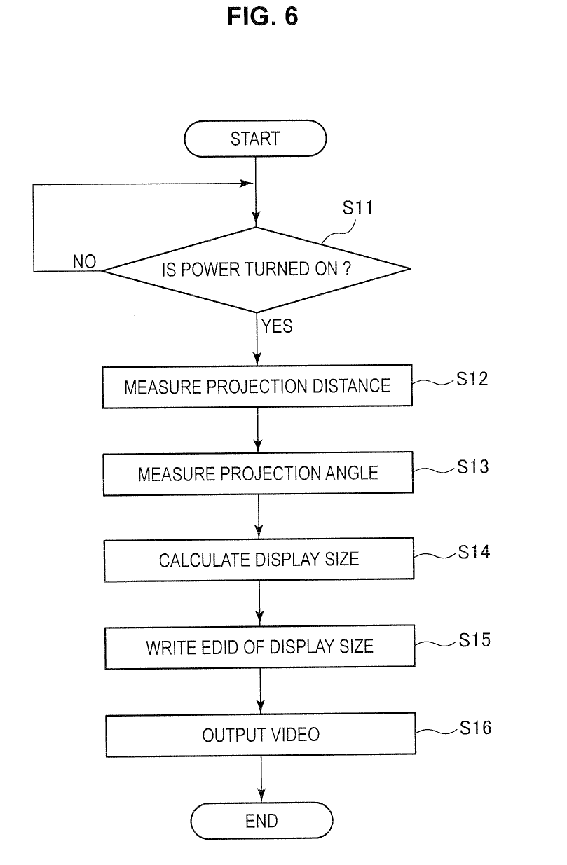

4. Process of Acquiring Display Size by Turning on Power (FIG. 6)

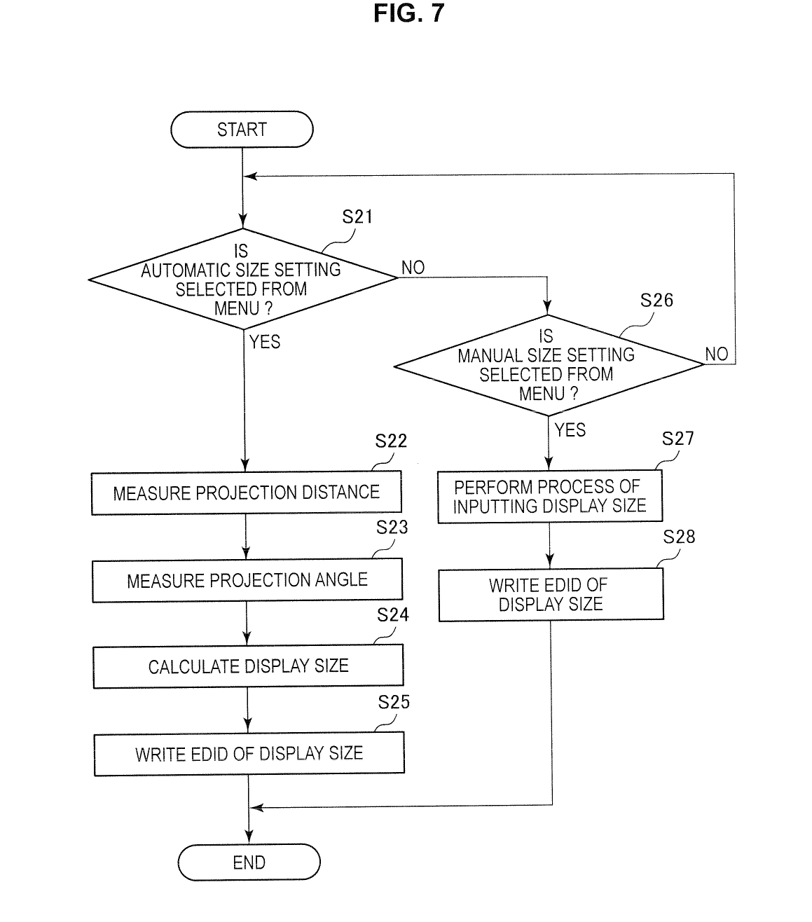

5. Process of Acquiring Display Size by Menu Operation (FIG. 7)

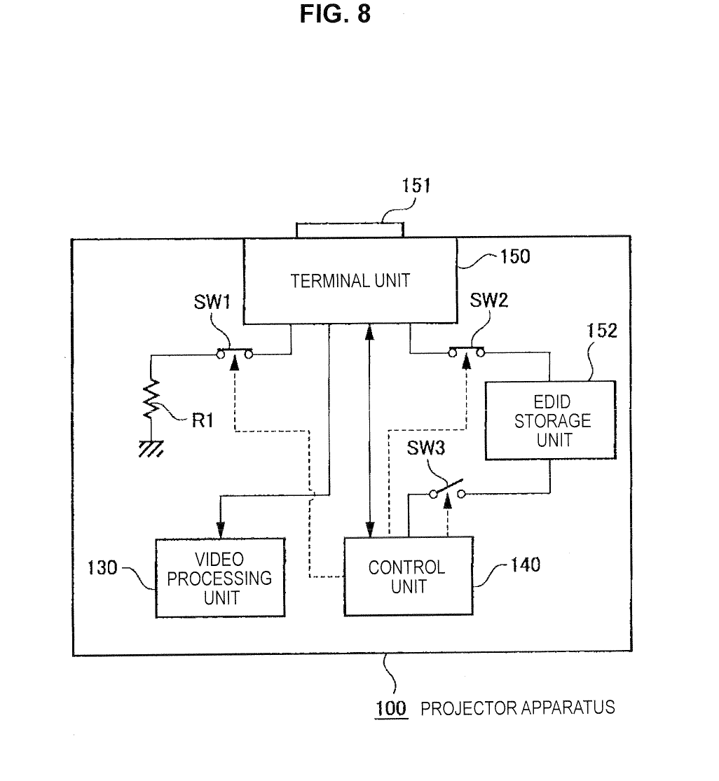

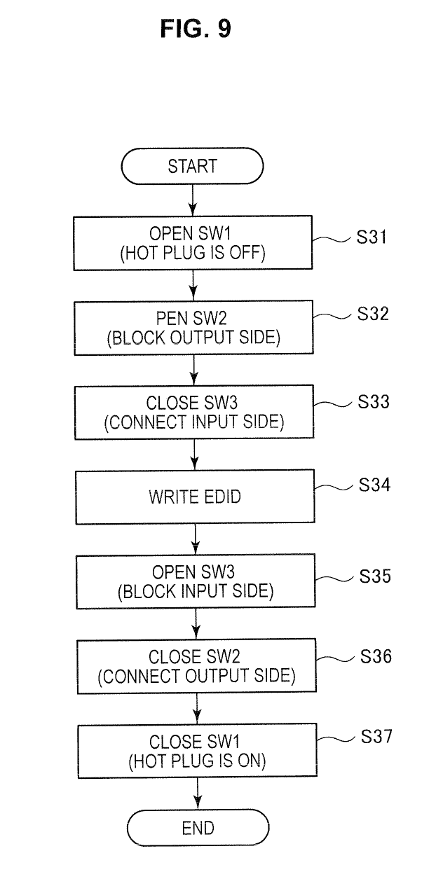

6. Process of Setting EDID (FIGS. 8 and 9)

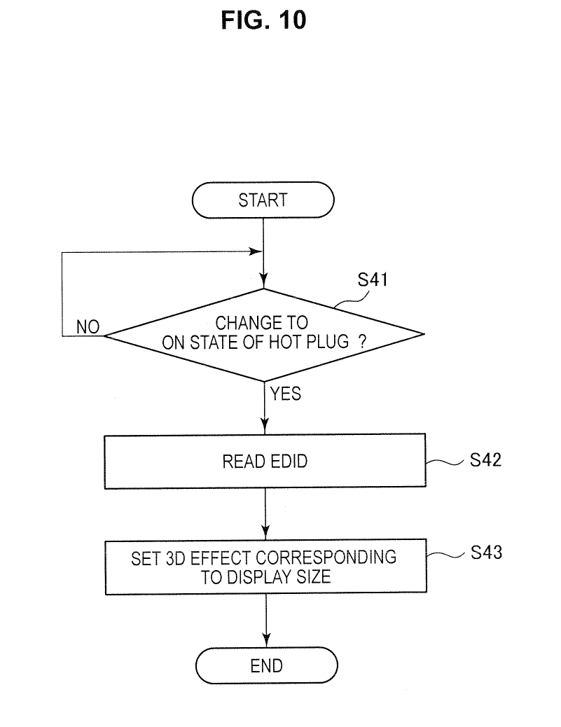

7. Process of Reproduction Apparatus (FIG. 10)

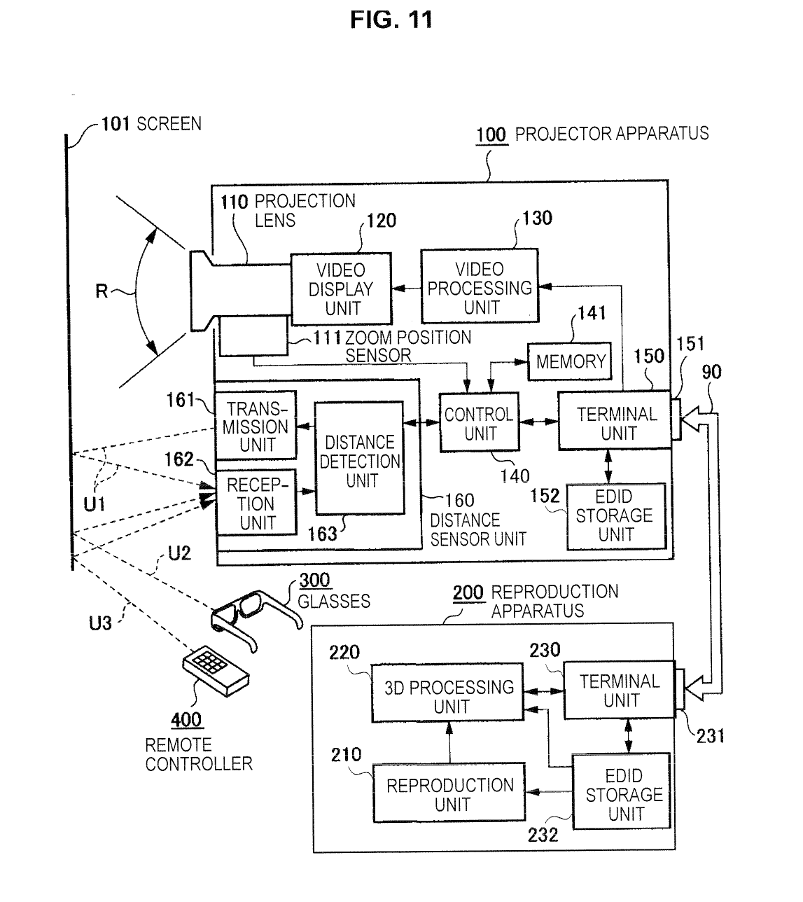

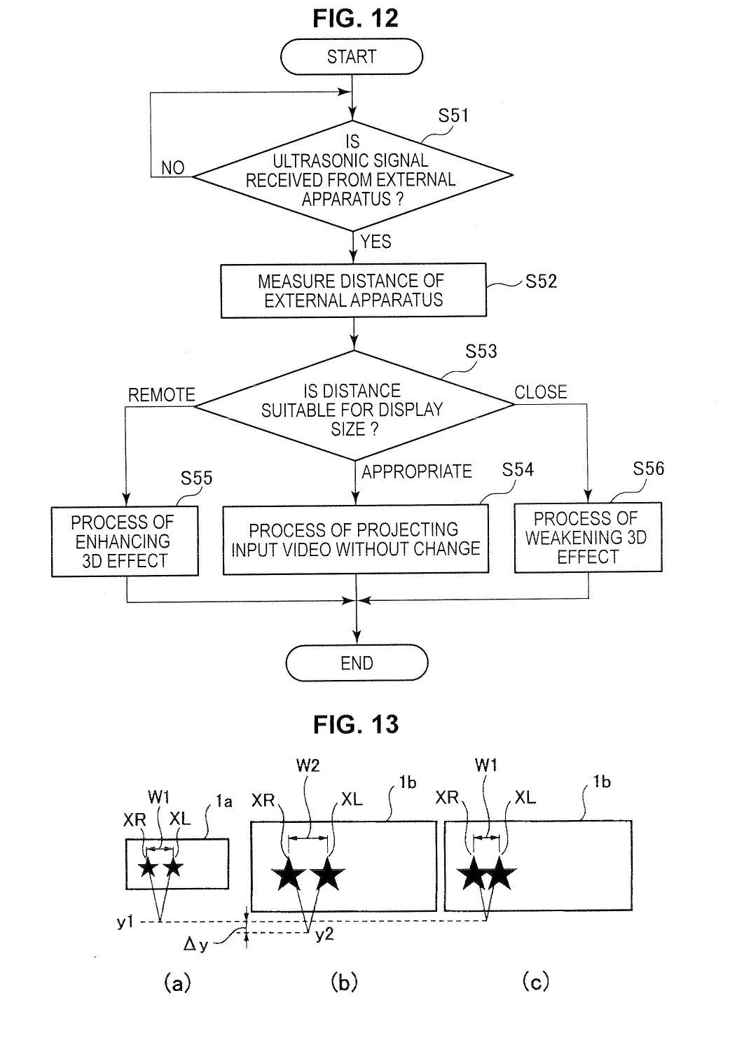

8. Modified Examples (FIGS. 11 and 12)

### 1. CONFIGURATIONS OF PROJECTOR APPARATUS AND REPRODUCTION APPARATUS

FIG. 1 is a diagram illustrating the configuration of a system including a projector apparatus and a reproduction apparatus according to an embodiment of the present disclosure.

A projector apparatus 100 is an apparatus that projects a video on a screen 101 through a projection lens 110. The projector apparatus 100 includes a terminal unit conforming to the high-definition multimedia interface (HDMI) standard and is connected to a reproduction apparatus 200 using an HDMI cable 90. Video data obtained by reproducing a disc or the like by the reproduction apparatus 200 is transmitted to the projector apparatus 100 via the HDMI cable 90. Then, the projector apparatus 100 projects a video on the screen 101.

The HDMI standard, which is a digital video and audio input and output interface standard, can transmit video data or audio data and transmit various control data or the like bi-directionally. In the HDMI standard, an apparatus that outputs a video and an audio is referred to as a source apparatus and an apparatus to which the video and the audio are input is referred to as a sink apparatus. One of the data that the sink apparatus transmits to the source apparatus in conformity to the HDMI standard is data (which is EDID to be described below) regarding a display capability of the sink apparatus (display apparatus).

In the embodiment, the projector apparatus 100 and the reproduction apparatus 200 can each process a stereoscopic video. That is, the reproduction apparatus 200 reproduces 3D video data formed by right-eye and left-eye images and transmits the reproduced 3D video data to the projector apparatus 100. That is, in the case of stereoscopic video data, the reproduction apparatus 200 alternately or individually provides right-eye and left-eye images to the projector apparatus 100 at one frame period via the HDMI cable 90.

When receiving the 3D video data, the projector apparatus 100 alternately projects the right-eye and left-eye videos to the screen 101 at one frame period. Then, right-eye and left-eye liquid crystal shutters of 3D display glasses (not shown) are alternately opened and closed at each frame in synchronization with a display timing of the video. Thus, when a user wearing the 3D display glasses views the screen 101, the user can perceive a stereoscopic display image.

Further, there are various methods of stereoscopically viewing a video. The method using glasses including liquid crystal shutters is merely one example. Projector apparatuses stereoscopically displaying a video in accordance with other methods may also be used.

As shown in FIG. 1, the projector apparatus 100 projects a video to the screen 101 through the projection lens 110. In this embodiment, the projector apparatus 100 uses a zoom lens as the projection lens 110. Accordingly, a projection size of the video to be projected to the screen 101, that is, a display size of the video on the screen 101, can be set to be variable by adjusting the projection angle R of the projection lens 110. The projector apparatus 100 includes a distance sensor unit 160 that detects the distance between the projector apparatus 100 and the screen 101. The distance sensor unit 160 measures the distance by transmitting ultrasonic waves U1 and receiving the ultrasonic waves U1 reflected from the screen 101. A specific process of detecting the distance will be described later.

Next, the internal configurations of the projector apparatus 100 and the reproduction apparatus 200 will be described with reference to FIG. 2.

The reproduction apparatus 200 includes a reproduction unit 210 that reproduces a disc or the like. The reproduction apparatus 200 supplies video data obtained through reproduction of the reproduction unit 210 to a stereoscopic video processing unit 220. The stereoscopic video processing unit 220 performs a stereoscopic process when the video data reproduced by the reproduction unit 210 is stereoscopic video data. Specifically, a parallax between right-eye and left-eye images is adjusted.

Then, the video data adjusted by the stereoscopic video processing unit 220 is supplied to a terminal unit 230. The terminal unit 230 is a terminal conforming to the HDMI standard and connects the HDMI cable 90 to a cable connection port 231.

An EDID detection unit 232 is connected to the terminal unit 230. Therefore, data of extended display identification data (EDID) stored in an EDID storage unit of the sink apparatus is detected by the EDID detection unit 232. The data of the EDID is data regarding a video display capability of the sink apparatus. For example, the data of the EDID indicates a video display resolution in the sink apparatus, a video format that the sink apparatus can input, or the like. Further, the data regarding the EDID includes data regarding a display size of a video displayed by the sink apparatus.

When the EDID detection unit 232 detects the data of the EDID and confirms that the sink apparatus capable of displaying a stereoscopic video is connected, the reproduction unit 210 reproduces stereoscopic video data and the stereoscopic video processing unit 220 performs a stereoscopic process. The display size included in the data of the EDID is detected by the EDID detection unit 232 and the data is processed to video data suitable for the display size by the reproduction unit 210 or the stereoscopic video processing unit 220.

Next, the configuration of the projector apparatus 100 will be described.

The projector apparatus 100 includes a terminal unit 150 conforming to the HDMI standard. The HDMI cable 90 is connected to a cable connection port 151. The terminal unit 150 includes an EDID storage unit 152. The EDID storage unit 152 is a memory that stores the data regarding the video display capability of the projector apparatus 100. For example, a memory capable of electrically rewriting stored data is used as the EDID storage unit 152. For example, an electrically erasable programmable read-only memory (EEPROM) is used.

One of the data regarding the video display capability stored by the EDID storage unit 152 is data regarding the display size of a video. The data regarding the display size of a video is updated under the control of a control unit 140.

When the terminal unit 150 receives the video data via the HDMI cable 90, the terminal unit 150 supplies the received video data to the video processing unit 130. Then, the video processing unit 130 processes the video data for display. The video data processed by the video processing unit 130 is supplied to the video projection processing unit 120. For example, the video projection processing unit 120 includes a display panel that displays a video and an optical system mechanism that projects light from a light source to the video displayed on the display panel. The light transmitted through the display panel is incident on the projection lens 110 and the video is projected to the screen 101 through the projection lens 110.

The projection lens 110 according to this embodiment is a zoom lens. The projection lens 110 includes a zoom position sensor 111 that detects a zoom position. The zoom position sensor 111 is a sensor that forms a projection angle detection unit. The zoom position sensor 111 configures data regarding the zoom position detected by the zoom position sensor 111 as data regarding a lens position corresponding to a projection angle R and supplies this data to the control unit 140. Adjustment of the zoom position of the projection lens 110 may be realized by an electric operation type in which driving is performed by a motor or a manual type in which a user manually operates the zoom position.

The projector apparatus 100 includes a distance sensor unit 160 that detects the distance between the projector apparatus 100 and the screen 101 to which the video is projected through the projection lens 110.

That is, the distance sensor unit 160 includes a transmission unit 161 that transmits ultrasonic waves and a reception unit 162 that receives the ultrasonic waves. A distance detection unit 163 detects the distance between the projector apparatus 100 and the screen 101 based on a time difference between a transmission timing in the transmission unit 161 and a reception timing in the reception unit 162. Then, data regarding the distance between the projector apparatus 100 and the screen 101 detected by the distance sensor unit 160 is supplied to the control unit 140.

The control unit 140 calculates the size of the video projected to the screen 101 based on the data regarding the distance between the projector apparatus 100 and the screen 101 detected by the distance sensor unit 160 and the data regarding the zoom position detected by the zoom position sensor 111. This calculation process is performed by substituting the data regarding the distance and the data regarding the zoom position to a prepared calculation equation.

When the control unit 140 calculates data regarding the size of the video, the calculated data regarding the size of the video is written on a section of the data regarding the size of the video in the EDID storage unit 152 provided in the terminal unit 150 and the data of the size of the video in the EDID storage unit 152 is updated. A timing at which the process of updating the data regarding the size of the video in the EDID storage unit 152 is performed will be described later.

### 2. CONFIGURATION OF TRANSMISSION AND RECEPTION WITH HDMI CABLE

Next, a transmission order between the projector apparatus and the reproduction apparatus 200, which is a partner apparatus when the HDMI cable 90 is connected to the terminal unit 150 serving as a video data input unit of the projector apparatus 100, will be described with reference to FIG. 3. As described above, when the apparatuses are connected to each other via the HDMI cable 90, an apparatus that outputs video data is referred to as a source apparatus and an apparatus to which the video data is input is referred to as a sink apparatus.

The projector apparatus 100 serves as the sink apparatus. In FIG. 3, for example, the reproduction apparatus 200 serving as the source apparatus and the terminal unit 150 of the projector apparatus 100 are connected to each other via the HDMI cable 90. In FIG. 3, data transmission channels are shown and cable connection ports are not shown.

The reproduction apparatus 200 includes a reproduction unit 210 and a stereoscopic video processing unit 220 which are a source signal processing unit. Video data, audio data, and control data output by the stereoscopic video processing unit 220 are supplied to an HDMI processing unit 233 of the terminal unit 230. The HDMI processing unit 233 divides and arranges the video data, the audio data, and the control data to three channels, TMDS channels 0, 1, and 2, and outputs the data arranged in the channels. TMDS is an abbreviation for transition minimized differential signaling. Further, a clock is arranged and output to a TMDS clock channel. The data is transmitted to individual lines of the HDMI cable 90.

The data of the TMDS channels 0, 1, and 2 and the TMDS clock channel of the reproduction apparatus 200 are received by the HDMI processing unit 153 of the terminal unit 150 of the projector apparatus 100 serving as the sink apparatus and are divided into video data, audio data, and control data. The divided video data, audio data, and control data are supplied to respective units of the projector apparatus 100. For example, the received video data is supplied to the video processing unit 130 shown in FIG. 2. The received control data is supplied to the control unit 140. Further, the received audio data is supplied to an audio data processing unit (not shown). When the projector apparatus 100 includes no audio data processing unit, the projector apparatus 100 does not process the received audio data.

As other lines used to transmit data via the HDMI cable 90, a display data channel (DDC) and a consumer electronics control (CEC) line are provided to transmit the data to the channels or lines bi-directionally. In the DDC, the EDID stored in the EDID storage unit 112 of the projector apparatus 100 serving as the sink apparatus is read by the HDMI processing unit 233 of the reproduction apparatus 200 serving as the source apparatus and is acquired by the EDID detection unit 232 shown in FIG. 2. The DDC is used to exchange other data between the HDMI processing unit 233 of the reproduction apparatus 200 and the HDMI processing unit 153 of the sink apparatus (the projector apparatus 100). The CEC line is used to transmit the control data or the like bi-directionally.

### 3. PROCESS OF DETECTING DISPLAY SIZE

Next, a process of detecting the size of the video projected by the projector apparatus 100 will be described.

To detect the size of the projection video, the distance between the projection lens 110 of the projector apparatus 100 and the screen 101 and the projection angle of the projection lens 110 are necessary.

The distance between the projection lens 110 of the projector apparatus 100 and the screen 101 is detected by the distance sensor unit 160. The distance detection unit 163 of the distance sensor unit 160 detects the distance between the projection lens 110 and the screen 101 based on a time difference between a transmission timing of ultrasonic waves in the transmission unit 161 and a reception timing of the ultrasonic waves in the reception unit 162. That is, as shown in FIG. 4A, the ultrasonic waves are output at a constant period from the transmission unit 161. As shown in FIG. 4B, the reception unit 162 detects time differences T1, T2, . . . , and Tn (where n is any integer) between the transmission timings and the reception timings of the ultrasonic waves.

Then, the distance detection unit 163 calculates an average value Ta of the detected time differences T1, T2, . . . , Tn, calculates the value of half of the obtained average value Ta, and converts the value of the half of the average value Ta into a projection distance L based on the sound speed of the ultrasonic waves. That is, the projection distance L is obtained by the following equation.

The value of the projection distance L obtained by “Projection Distance L=(Average Value Ta×Sound Speed)/2” is supplied to the control unit 140.

Next, the configuration of the projection lens 110 detecting a projection angle will be described with reference to FIG. 5.

The projection lens 110 includes the zoom position sensor 111. The zoom position sensor 111 detects an adjustment position of an adjustment lever adjusting a zoom position. The adjustment lever adjusting the zoom position can adjust the zoom position between the minimum position Vmin and the maximum position Vmax, as shown in FIG. 5. The projection angle of the projection lens 110 is set depending on a current position V.

The minimum position Vmin of the adjustment lever adjusting the zoom position corresponds to the minimum projection angle Rmin of the projection lens 110 and the maximum position Vmax corresponds to the maximum projection angle Rmax of the projection lens 110. Further, the current position V of the adjustment lever detected by the zoom position sensor 111 corresponds to the current projection angle R.

Accordingly, the current position V of the adjustment lever detected by the zoom position sensor 111 is supplied to the control unit 140. The control unit 140 performs a conversion calculation process to obtain the projection angle R. An example of the calculation equation used to obtain the projection angle R will be described below. A magnification factor a is a constant value determined in accordance with the characteristics of the projection lens 110.

Projection Angle R=Magnification Factor a×Current Position V×(Maximum Projection Angle Rmax−Minimum Projection Angle Rmin)/(Maximum Position Vmax−Minimum Position Vmin)

The size of the video projected to the screen 101 is obtained by performing calculation using the distance L between the projection apparatus 100 and the screen 101 and the projection angle R obtained by the control unit 140. For example, a display screen width W0 is obtained through calculation of the following equation.

Screen Width W0=Projection Distance L×tan(projection angle R)/2

When the screen width is obtained, the height of the screen is also determined from the aspect ratio of the display video. The width and height of the screen are set as data measured in units of millimeters.

### 4. PROCESS OF ACQUIRING DISPLAY SIZE BY TURNING ON POWER

Next, a process of acquiring the display size of the video projected by the projector apparatus 100 according to this embodiment will be described.

When the projector apparatus 100 is changed from a power-off state (or a standby state) of the projector apparatus 100 to a power-on state, the process of acquiring the display size of a video to be projected is performed. Further, the process of acquiring the display size of a video to be projected is also performed when a menu screen is displayed with the projector apparatus 100 and an operation of setting the display size is performed.

First, an example of the process of acquiring the display size when the power is turned on will be described with reference to the flowchart of FIG. 6.

When the control unit 140 of the projector apparatus 100 receives a power key operation or an instruction from a remote controller from a user, the control unit 140 determines whether the projector apparatus 100 is changed from the power-off state or the standby state to the power-on state (step S11).

When the control unit 140 determines that the projector apparatus 100 is changed to the power-on state, the distance sensor unit 160 performs a process of measuring the distance between the projector apparatus 100 and the screen 101 to acquire the measurement result (step S12). Then, the control unit 140 acquires the current position of the adjustment lever detected by the zoom position sensor 111 and converts the current position of the adjustment lever into the projection angle (step S13).

The control unit 140 calculates the display size of the video on the screen based on the acquired distance between the projector apparatus 100 and the screen 101 and the acquired projection angle (step S14). When the control unit 140 calculates the display size, the control unit 140 updates the data regarding the display size in the EDID storage unit 152 to data regarding the calculated display size (step S15). Then, video display (video projection) starts based on the video data input to the terminal unit 150 (step S16) and the power-on process ends.

### 5. PROCESS OF ACQUIRING DISPLAY SIZE BY MENU OPERATION

FIG. 7 is a flowchart illustrating an example of the process of acquiring the display size through a menu screen operation.

The projector apparatus 100 according to this embodiment prepares the item of “automatic display size setting” and the item of “manual display size setting” as items displayed on a menu screen. The menu screen is displayed in the video projected to the screen 101, for example, when the user presses down a menu key of the projector apparatus 100 or the remote controller. Further, each display item of the menu screen is selected through a key operation prepared in the projector apparatus 100 or the remote controller.

The control unit 140 determines whether the item of “automatic display size setting” is selected when the menu screen is displayed (step S21). Here, when the control unit 140 determines that the item of “automatic display size setting” is selected, the distance sensor unit 160 performs the process of measuring the distance between the projector apparatus 100 and the screen 101 to obtain the measurement result (step S22). Then, the control unit 140 acquires the current position of the adjustment lever detected by the zoom position sensor 111 and converts the current position of the adjustment lever into the projection angle (step S23).

Next, the display size of the video on the screen is calculated based on the acquired distance between the projector apparatus 100 and the screen 101 and the acquired projection angle (step S24). When the control unit 140 calculates the display size, the control unit 140 updates the data regarding the display size in the EDID storage unit 152 to data regarding the calculated display size (step S25).

When the control unit 140 determines that the item of “automatic display size setting” is not selected in step S21, the control unit 140 determines whether the item of “manual display size setting” is selected (step S26). Here, when the control unit 140 determines that the item of “manual display size setting” is selected, the control unit 140 displays an item for inputting the vertical and horizontal sizes of the screen in the video projected to the screen 101 (step S27). The user using the remote controller operates the input of numerical values for each item. Then, the control unit 140 updates the data regarding the display size in the EDID storage unit 152 to data regarding the display size input through the user's operation (step S28).

Conversely, when the control unit 140 determines that the item of “manual display size setting” is not selected in step S26, the process returns to the determination of step S21 and the determination is repeated during the display of the menu screen.

### 6. PROCESS OF SETTING EDID

Next, a configuration and a process of updating the data regarding the display size in the EDID storage unit 152 will be described.

First, the configuration in which the data stored in the EDID storage unit 152 is updated will be described with reference to FIG. 8.

When the HDMI cable 90 is connected to the cable connection port 151 of the terminal unit 150 conforming to the HDMI standard, video data received via the HDMI cable 90 is supplied to the video processing unit 130. Further, control data received via the HDMI cable 90 by the terminal unit 150 is supplied to the control unit 140 and control data from the control unit 140 is transmitted from the terminal unit 150 to the HDMI cable 90.

To transmit and receive the data via the HDMI cable 90, a line for a hot plug in the HDMI cable 90 should have a predetermined potential. Therefore, the line for the hot plug is grounded via a switch SW1 and a resistor R1.

A line used for the terminal unit 150 to read the data stored in the EDID storage unit 152 is connected via a switch SW2 and a write data supply line of the EDID storage unit 152 is connected to the control unit 140 via a switch SW3.

The switches SW1, SW2, and SW3 are switches that are controlled to be opened or closed by the control unit 140. The switches SW1 and SW2 are closed and the switch SW3 is opened in order to transmit data to the HDMI cable 90 connected to the terminal unit 150.

In order for the control unit 140 to update the data stored in the EDID storage unit 152, the switch SW1 connected to the line for the hot plug is opened so that data transmitted via the HDMI cable 90 is interrupted. Further, the switch SW2 connected to the line used to read the data stored in the EDID storage unit 152 is opened so that data is not read, and the switch SW3 is closed so that the updated data can be supplied from the control unit 140 to the EDID storage unit 152.

FIG. 9 is a flowchart illustrating a process of writing the data regarding the display size on the EDID storage unit 152 configured as in FIG. 8.

The processes of the flowchart of FIG. 8 correspond to the processes of writing the display size in step S15 of the flowchart of FIG. 6 and step S25 of the flowchart of FIG. 7.

First, the control unit 140 sets the switch SW1 from the closed state to the opened state so that the hot plug is off and data is not transmitted to the HDMI cable 90 (step S31). The switch SW2 is set from the closed state to the opened state and the output side of the EDID storage unit 152 is blocked so that the terminal unit 150 may not read the data stored in the EDID storage unit 152 (step S32).

Then, the switch SW3 is set from the opened state to the closed state so that the input side of the EDID storage unit 152 is connected (step S33). In this state, the control unit 140 supplies the data regarding the acquired display size to the EDID storage unit 152 and writes the data in the memory to update the display size to be suggested to the source apparatus (the reproduction apparatus 200) (step S34).

Thereafter, the control unit 140 returns the closed state of the switch SW3 to the opened state (step S35) and returns the opened state of the switch SW2 to the closed state (step S36). Through this process, the terminal unit 150 can read the data stored in the EDID storage unit 152. Further, the control unit 140 returns the opened state of the switch SW1 to the closed state and thus the line for the hot plug has the predetermined potential again (step S37) so that the data can be transmitted via the HDMI cable 90.

The display size stored by the EDID storage unit 152 is updated to the display size of the video actually detected in the projector apparatus 100 and the updated display size is transmitted to the source apparatus (the reproduction apparatus 200) via the HDMI cable 90.

### 7. PROCESS OF REPRODUCTION APPARATUS

FIG. 10 is a flowchart illustrating an example of a process when the reproduction apparatus 200 reads the data regarding the display size.

First, the reproduction apparatus 200 determines whether the state of the HDMI cable 90 detected by the terminal unit 230 is changed from the OFF state of the hot plug to the ON state (step S41). When the reproduction apparatus 200 determines that the hot plug remains in the OFF state, the reproduction apparatus 200 waits until the state of the hot plug is changed to the ON state. When the 20reproduction apparatus 200 detects that the state of the hot plug is changed to the ON state, the EDID detection unit 232 reads the data stored in the EDID storage unit 152 of the projector apparatus 100 and acquires the data regarding the display size of the projector apparatus 100 (step S42).

The acquired data regarding the display size is supplied to the stereoscopic video processing unit 220. When the stereoscopic video processing unit 220 confirms that the projector apparatus 100 can process the stereoscopic video from the video data reproduced by the reproduction unit 210 to the video data to be stereoscopically viewed based on the data of the EDID, the stereoscopic video processing unit 220 performs a corresponding stereoscopic video process (step S43). For example, the stereoscopic video processing unit 220 sets a parallax between the right-eye and left-eye videos which corresponds to the display size indicated by the data of the EDID.

A process of setting an appropriate parallax between the right-eye and left eye videos which corresponds to the display size is the process described in BACKGROUND with reference to FIGS. 13A to 13C.

Thus, the reproduction apparatus 200 serving as the source apparatus acquires the display size of the video on the screen 101 detected by the projector apparatus 100 and can set an appropriate parallax when the stereoscopic video data is generated. Thus, a constant appropriate stereoscopic sense can be obtained without dependency on the display size.

### 8. MODIFIED EXAMPLES

In the above-described embodiment, the detection unit that detects (measures) the distance by transmitting and receiving the ultrasonic waves is used as a detection unit that detects the distance between the projector apparatus and the screen included in the projector apparatus. However, a detection unit that detects the distance using another signal such as a laser beam may be used.

In the above-described embodiment, the projector apparatus has no configuration for right and left parallax adjustment of stereoscopic video data. However, the projector apparatus has a configuration for adjustment of a parallax between right-eye and left-eye videos in accordance with a calculated display size.

In the projector apparatus, a parallax between the right-eye and left-eye video may be adjusted in accordance with a factor different from a calculated screen size.

For example, as shown in FIG. 11, stereoscopic viewing glasses 300 or a remote controller 400 are prepared separately from the projector apparatus 100. When the glasses 300 open and close right-eye and left-eye liquid crystal shutters in synchronization with the display of the right-eye and left-eye videos of the projector apparatus 100, a user wearing the glasses 300 can stereoscopically perceive the videos.

In the example of FIG. 11, the glasses 300 or the remote controller 400 includes an ultrasonic wave transmission unit. The reception unit 162 of the distance sensor unit 160 of the projector apparatus 100 receives reflected waves of ultrasonic waves U2 transmitted from the glasses 300 to the screen 101. Alternatively, the reception unit 162 of the distance sensor unit 160 of the projector apparatus 100 receives reflected waves of ultrasonic waves U3 transmitted from the remote controller 400 to the screen 101. The ultrasonic waves U2 and U3 may not be the reflected waves reflected from the screen 101. The reception unit 162 may directly receive the waves from the glasses 300 or the remote controller 400.

Then, the control unit 140 estimates the viewing position of a user wearing the glasses 300 or a user who operates the remote controller 400 based on the ultrasonic waves U2 or U3 received by the reception unit 162. The control unit 140 of the projector apparatus determines whether the estimated viewing position is a position close to a standard viewing position for stereoscopic view, or is a position located to the front or the rear of the standard viewing position, and then adjusts the parallax between right and left videos.

The projector apparatus 100 shown in FIG. 11 has the same configuration as the projector apparatus 100 shown in FIG. 2 except that the reception unit 162 of the distance sensor unit 160 receives the ultrasonic waves from an external apparatus and determines the distance between the projector apparatus 100 and the screen 101.

FIG. 12 is a flowchart illustrating an example of processes of receiving the ultrasonic waves from an external apparatus and adjusting the parallax between right and left videos in the projector apparatus 100.

First, the control unit 140 determines whether the reception unit 162 receives an ultrasonic signal from an external apparatus (the glasses 300 or the remote controller 400) (step S51). Then, the distance between the external apparatus and the screen 101 is measured (estimated) from the reception timing of the ultrasonic signal (step S52). The distance between the screen 101 and the projector apparatus 100 is already acquired through the above-described processes. Thus, the distance between the external apparatus and the screen 101 can be obtained from a difference between the distance between the screen 101 and the projector apparatus 100 and the distance between the external apparatus and the projector 100.

It is determined whether a position distant by the acquired distance between the external apparatus and the screen 101 is an appropriate viewing position, a position more remote from the screen than the standard viewing position, or a position closer to the screen than the standard viewing position (step S53).

When it is determined that the distance between the external apparatus and the screen 101 is the substantially appropriate viewing position, the video data input to the terminal unit 150 is projected and displayed with the parallax without adjustment.

When it is determined that the position distant by the acquired distance is the position more remote from the screen than the standard viewing position, an enhancement process of enlarging the parallax between the right-eye and left-eye videos and enhancing a stereoscopic effect is performed and the enhanced video is projected and displayed.

When it is determined that the position distant by the acquired distance is the position closer to the screen than the standard viewing position, a process of narrowing the parallax between the right-eye and left-eye videos and weakening the stereoscopic effect is performed and the weakened video is projected and displayed.

Thus, the process of enhancing the parallax or the process of weakening the parallax is performed depending on the position of the user viewing the projection video. Wherever the user is located, a video of an appropriate stereoscopic sense can be displayed.

The EEPROM described above in the embodiment has been used as a memory forming the EDID storage unit described in the embodiment. However, another non-volatile memory may be used.

For example, various non-volatile memories such as a flash memory, a non-volatile RAM (NVRAM), a ferroelectric RAM (FeRAM), or a magnetoresistive RAM (MRAM) may be used as the memory forming the EDID storage unit. An EEPROM or a flash memory is a non-volatile memory capable of electrically rewriting stored data. An NVRAM is a non-volatile memory that includes a battery for memory backup. A FeRAM is a non-volatile memory that uses a ferroelectric in a storage element. An MRAM is a non-volatile memory that uses a magnetic body in a storage element.

The configuration of the EDID storage unit shown in FIG. 1 has been described as an example of a dedicated memory. However, the EDID storage unit may be configured using a partial storage region of another non-volatile memory of a video display apparatus.

In the above-described embodiment, the terminal conforming to the HDMI standard has been used as a video input terminal, but a terminal unit conforming to another standard may be used. In the case of a terminal unit of another interface, the terminal unit is applicable to the format, type, or the like of input-enabled video data prepared for each interface.

For example, the digital visual interface (DVI) standard, a displayport standard, or a D-subminiature (D-sub) standard may be applied. In these standards, EDID (or other data with the same name) is prepared as the data regarding the display capability of a projector apparatus and an item of the display size of the data can be set in accordance with the detected display size.

In the above-described embodiment, the display size indicted by the data of the EDID has been applied to the process when the parallax or the like is set in the stereoscopic view. However, when video data for normal 2D display is processed, the display size indicated by the data of EDID or the like may be applied. For example, the details of a resolution, a frame rate, or the like of video data output from the source apparatus may be set to have a value suitable for the display size, and the video data with the set resolution or the like may be supplied to the sink apparatus (projector apparatus) and may be displayed.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

### (1) A Projector Apparatus Including:

a terminal unit that is supplied with video data output by a source apparatus and transmits data regarding a display capability of the projector apparatus to the source apparatus;

a video projection processing unit that generates a projection video based on the video data input to the terminal unit and projects the generated projection video through a projection lens;

a distance detection unit that detects a distance to a display surface on which the projection video projected through the projection lens is displayed;

a projection angle detection unit that detects a projection angle of the projection video projected through the projection lens; and

a control unit that calculates a display size of the projection video on the display surface based on the distance detected by the distance detection unit and the projection angle detected by the projection angle detection unit and transmits the calculated display size as the data regarding the display capability of the projector apparatus from the terminal unit to the source apparatus.

### (2) The Projector Apparatus According to (1), Further Including:

a data storage unit that stores the data regarding the display capability transmitted to the source apparatus by the terminal unit,

wherein the display size calculated by the control unit is stored in the data storage unit.

### (3) The Projector Apparatus According to (1) or (2),

wherein, when an operation of turning on power of the projector apparatus or an operation of updating the display size is performed, the data regarding the display size, which is calculated by the control unit and is stored in the data storage unit, is updated with the calculated display size.

### (4) The Projector Apparatus According to Any One of (1) to (3),

wherein the control unit updates the data regarding the display size stored in the data storage unit in a state where the control unit performs an invalidation process of causing the data not to be transmitted to the source apparatus via the terminal unit, and cancels the invalidation process after updating the data.

### (5) The Projector Apparatus According to Any One of (1) to (4),

wherein the video data input by the terminal unit is video data for which right-eye and left-eye videos of stereoscopic video data are alternately or individually supplied, and

wherein the video projection processing unit alternately projects the right-eye and left-eye videos at a predetermined period on the display surface.

### (6) The Projector Apparatus According to Any One of (1) to (5),

wherein the control unit estimates a distance between the display surface and a position of a user who views the videos projected to the display surface, and adjusts a parallax between the right-eye and left-eye videos of the video data input to the terminal unit based on the estimated distance.

### (7) A Video Display Method Comprising:

generating a projection video based on video data input from a source apparatus to a terminal unit and displaying the projection video by projecting the generated projection video through a projection lens;

detecting a distance to a display surface on which the projection video projected through the projection lens is displayed;

detecting a projection angle of the projection video projected through the projection lens;

calculating a display size of the projection video on the display surface based on the distance detected in detecting the distance and the projection angle detected in detecting the projection angle; and

transmitting the display size calculated in calculating the display size to the source apparatus.

The present disclosure contains subject matter related to that disclosed in Japanese Priority Patent Application JP 2011-216698 filed in the Japan Patent Office on Sep. 30, 2011, the entire content of which is hereby incorporated by reference.

What is claimed is:

1. A projector apparatus comprising:
a terminal unit that is supplied with video data output by a source apparatus and transmits data regarding a display capability of the projector apparatus to the source apparatus;
a video projection processing unit that generates a projection video based on the video data input to the terminal unit and projects the generated projection video through a projection lens;
a distance detection unit that detects a distance to a display surface on which the projection video projected through the projection lens is displayed;
a projection angle detection unit that detects a projection angle of the projection video projected through the projection lens; and
a control unit that calculates a display size of the projection video on the display surface based on the distance detected by the distance detection unit and the projection angle detected by the projection angle detection unit and transmits the calculated display size as the data regarding the display capability of the projector apparatus from the terminal unit to the source apparatus.

2. The projector apparatus according to claim 1, further comprising:
a data storage it that stores the data regarding the display capability transmitted to the source apparatus by the terminal unit,
wherein the display size calculated by the control unit is stored in the data storage unit.

3. The projector apparatus according to claim 2,
wherein, when an operation of turning on power of the projector apparatus or an operation of updating the display size is performed, the data regarding the display size, which is calculated by the control unit and is stored in the data storage unit, is updated with the calculated display size.

4. The projector apparatus according to claim 3,
wherein the control unit updates the data regarding the display size stored in the data storage unit in a state where the control unit performs an invalidation process of causing the data not to be transmitted to the source apparatus via the terminal unit, and cancels the invalidation process after updating the data.

5. The projector apparatus according to claim 1,
wherein the video data input by the terminal unit is video data for which right-eye and left-eye videos of stereoscopic video data are alternately or individually supplied, and
wherein the video projection processing unit alternately projects the right-eye and left-eye videos at a predetermined period on the display surface.

6. The projector apparatus according to claim 5,
wherein the control unit estimates a distance between the display surface and a position of a user who views the videos projected to the display surface, and adjusts a parallax between the right-eye and left-eye videos of the video data input to the terminal unit based on the estimated distance.

7. A video display method comprising:
generating a projection video based on video data input from a source apparatus to a terminal unit and displaying the projection video by projecting the generated projection video through a projection lens;
detecting a distance to a display surface on which the projection video projected through the projection lens is displayed;
detecting a projection angle of the projection video projected through the projection lens;
calculating a display size of the projection video on the display surface based on the distance detected in detecting the distance and the projection angle detected in detecting the projection angle; and
transmitting the display size calculated in calculating the display size to the source apparatus.
